(19) United States
(12) Patent Application Publication
(10) Pub. No.: US 2014/0104386 A1
(43) Pub. Date: Apr. 17, 2014

(54) OBSERVATION SUPPORT DEVICE, OBSERVATION SUPPORT METHOD AND COMPUTER PROGRAM PRODUCT

(71) Applicant: KABUSHIKI KAISHA TOSHIBA, Tokyo (JP)

(72) Inventors: Kenichi SHIMOYAMA, Tokyo (JP); Akihito SEKI, Kanagawa (JP); Satoshi ITO, Kanagawa (JP); Masaki YAMAZAKI, Tokyo (JP); Yuta ITOH, Kanagawa (JP); Ryuzo OKADA, Kanagawa (JP)

(73) Assignee: KABUSHIKI KAISHA TOSHIBA, Tokyo (JP)

(21) Appl. No.: 13/826,719

(22) Filed: Mar. 14, 2013

(30) Foreign Application Priority Data
Aug. 9, 2012 (JP) 2012-176664

(51) Int. Cl. H04N 13/02; G06T 17/00

(52) U.S. Cl. CPC H04N 13/0275; G06T 17/00
USPC 348/46

(57) ABSTRACT

According to an embodiment, an observation support device includes an acquiring unit, a determining unit, and a generating unit. The acquiring unit is configured to acquire observation information capable of identifying an observing direction vector indicating an observing direction of an observing unit that observes an object for which a three-dimensional model is to be generated. The determining unit is configured to determine whether or not observation of the object in a direction indicated by an observed direction vector in which at least part of the object can be observed is completed based on a degree of coincidence of the observing direction vector and the observed direction vector. The generating unit is configured to generate completion information indicating whether or not observation of the object in the direction indicated by the observed direction vector is completed.

### CROSS-REFERENCE TO RELATED APPLICATION(S)

This application is based upon and claims the benefit of priority from Japanese Patent Application No. 2012-176664, filed on Aug. 9, 2012; the entire contents of which are incorporated herein by reference.

### FIELD

Embodiments described herein relate generally to an observation support device, an observation support method, and a computer program product.

### BACKGROUND

In recent years, there have been increasing demands for measuring three-dimensional shapes of objects to generate three-dimensional models in various fields. For example, there have been demands for measuring 1 and features in mapping and construction work and there have been demands for measuring shapes of buildings in social infrastructure sectors that conduct maintenance of buildings and the like. In addition, there also have been demands for measuring shapes of objects to be used for video pictures and the like, demands for measuring shapes of products for quality verification, and so on. In measuring a three-dimensional shape according to such a demand, it is particularly important that there is no omission in the measurement in order to obtain an accurate three-dimensional model. For example, a conventional technique of preventing omission in measurement by recording the direction in which an object is imaged and providing information of a direction in which the object has not been imaged as a next imaging direction is known.

Since, however, the conventional technique is on the assumption that an object is positioned at the center in the imaging direction and that imaging is performed in all directions from around and outside of the object, this technique cannot be applied to cases in which an object is imaged from inside thereof such as a case in which a wall surface (object) is imaged from inside a room. There is therefore a disadvantage that a next proper imaging direction cannot be informed and omission in measurement occurs.

### BRIEF DESCRIPTION OF THE DRAWINGS

FIG. 1 is a diagram illustrating an exemplary schematic configuration of an observation system according to an embodiment;

FIG. 2 is a diagram for explaining an observed direction vector;

FIGS. 3A and 3B are diagrams illustrating examples of three-dimensional object data;

FIG. 4 is a diagram illustrating an example of three-dimensional object data when observation is conducted from inside;

FIG. 5 is a diagram for explaining a relation between an observing direction vector and an observed direction vector;

FIG. 6 is a diagram for explaining an example of a method for setting the origin of three-dimensional object data;

FIG. 7 is a diagram for explaining an example of a method for setting the origin of three-dimensional object data;

FIG. 8 is a diagram for explaining an example of a method for setting the origin of three-dimensional object data;

FIG. 9 is a diagram for explaining an example of a method for setting the origin of three-dimensional object data;

FIG. 10 is a diagram illustrating an example of completion information; and

FIG. 11 is a flowchart illustrating an example of processing performed by the observation system.

### DETAILED DESCRIPTION

According to an embodiment, an observation support device includes an acquiring unit, a determining unit, and a generating unit. The acquiring unit is configured to acquire observation information capable of identifying an observing direction vector indicating an observing direction of an observing unit that observes an object for which a three-dimensional model is to be generated. The determining unit is configured to determine whether or not observation of the object in a direction indicated by an observed direction vector in which at least part of the object can be observed is completed based on a degree of coincidence of the observing direction vector information and the observed direction vector. The generating unit is configured to generate completion information indicating whether or not observation of the object in the direction indicated by the observed direction vector is completed.

Embodiments will be described in detail below with reference to the accompanying drawing. In the following description, a coordinate system in real space is expressed by (X, Y, Z) in which the vertical direction is represented by a Z axis, the horizontal directions are represented by an X axis and a Y axis, and the X-axis direction and the Y-axis direction are perpendicular to each other. Note that the coordinate system in real space is not limited thereto and may be set in any manner.

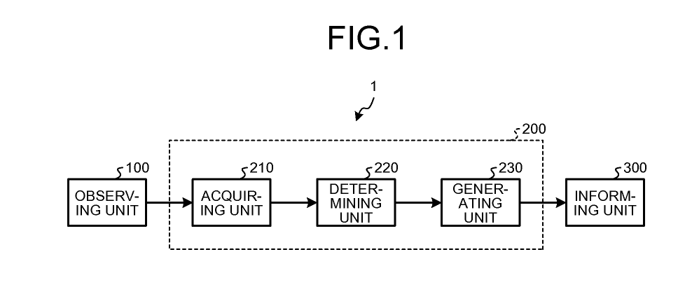

FIG. 1 is a diagram illustrating an exemplary schematic configuration of an observation system 1 that observes an object for which a three-dimensional model is to be formed. In the embodiment, a three-dimensional shape of an object can be measured from a result of observation of the object by the observation system 1, and a three-dimensional model of the object can be generated from the measurement result. Various known techniques can be used as a method for generating a three-dimensional model of an object. A three-dimensional model is data capable of expressing the shape of a three-dimensional object. As illustrated in FIG. 1, the observation system 1 includes an observing unit 100, an observation supporting unit 200, and an informing unit 300.

The observing unit 100 observes an object for which a three-dimensional model is to be formed. For example, the observing unit 100 can be a device such as a camera, a radar and a laser scanner capable of measuring a three-dimensional position of an object. For example, the configuration may be such that the observing unit 100 is composed of stereo cameras and measures a three-dimensional position of an object on the basis of the principle of triangulation.

The observation supporting unit 200 includes an acquiring unit 210, a determining unit 220, and a generating unit 230. The acquiring unit 210 acquires observation data representing a result of observation by the observing unit 100 and observation information that can identify an observing direction vector indicating an observing direction of the observing unit 100. The observing direction vector can be regarded as a vector indicating from which position and in which direction observation is conducted. Examples of the observation information mentioned above include information indicating the position and the posture at observation by the observing unit 100.

Note that any method for obtaining the position and the posture at observation by the observing unit 100 may be used. For example, a GPS, an accelerometer, a gyroscope or the like may be attached to the observing unit 100 for measurement. Alternatively, the position and the posture of the observing unit 100 can be measured by a camera or the like from outside. Still alternatively, the position and the posture of the observing unit 100 can be estimated by using a plurality of pieces of acquired observation data. For example, when images taken by a plurality of cameras are used as observation data, the positions and the postures of the observing unit 100 (cameras) can be estimated from shifted amounts indicating how much one position in real space is shifted in the images. The methods for measuring the position and the posture at observation of the observing unit 100 are not limited to those described above, and the position and the posture may be measured by a method other than those described above.

The determining unit 220 determines whether or not observation of an object in a direction indicated by an observed direction vector in which at least part of the object can be observed is completed on the basis of a degree of coincidence between an observing direction vector identified by observation information and the observed direction vector. More specifically, the following processing is performed. The determining unit 220 identifies an observing direction vector from observation information acquired by the acquiring unit 210. For example, when the observation information is information indicating the position and the posture of the observing unit 100, the determining unit 220 can calculate an observing direction vector by using the information indicating the position and the posture of the observing unit 100. The length of the observing direction vector can be set arbitrarily. For example, when the observing direction vector is regarded as a unit vector, the length of the observing direction vector may be set to 1.

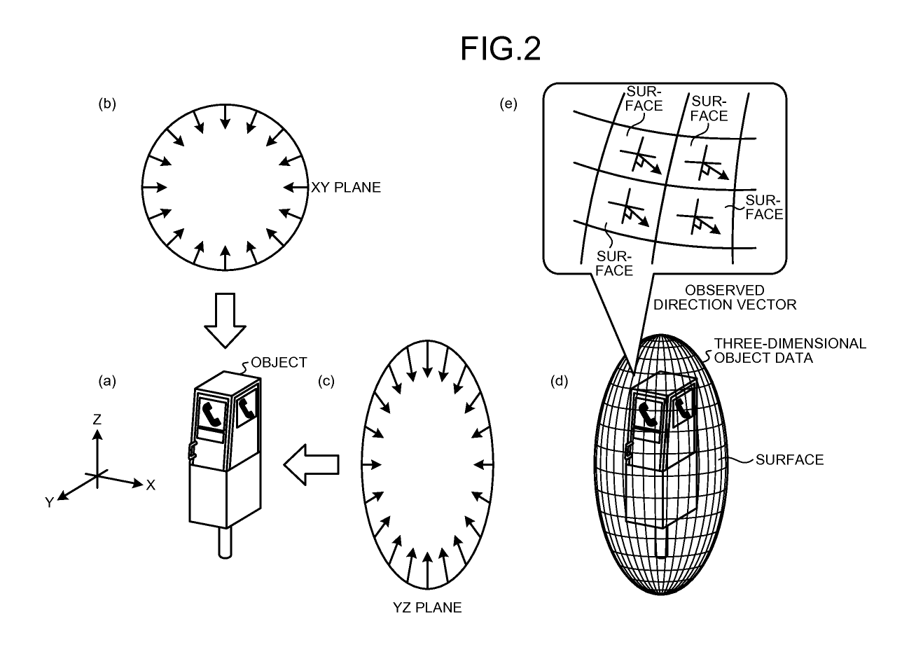

Note that an observed direction vector is a vector indicating a direction toward an object, that is, a vector indicating a direction in which at least part of the object can be observed. An observed direction vector can also be regarded as a vector indicating an observation direction in which a good observation result is likely to be obtained in observation of an object. The observed direction vector will be explained below with reference to FIG. 2.

FIG. 2 is a diagram for explaining an observed direction vector. The part (a) in FIG. 2 is a diagram illustrating an example of an object for which a three-dimensional model is to be generated. Arrows in the part (b) in FIG. 2 represent observed direction vectors on an XY plane, and indicate that it is preferable to observe an object in all directions on a horizontal plane (XY plane) from around the object. Similarly, arrows in the part (c) in FIG. 2 represent observed direction vectors on a YZ plane. Furthermore, the part (d) in FIG. 2 illustrates a state in which three-dimensional object data is arranged to enclose the object. The three-dimensional object data represents data of a three-dimensional object formed of a plurality of surfaces each intersecting with the corresponding observed direction vector.

While each of the surfaces constituting the three-dimensional object intersects at right angles with a corresponding one observed direction vector as illustrated in the part (e) in FIG. 2 in the embodiment, the intersection between a surface and an observed direction vector is not limited to that at right angles. Furthermore, in the embodiment, the three-dimensional object data are stored in advance in a memory that is not illustrated, and the determining unit 220 reads out the three-dimensional object data from the memory that is not illustrated for performing determination, which will be described later. Note that the three-dimensional object data may be stored anywhere, and the configuration may be such that the three-dimensional object data are stored in an external server, for example.

As will be described later, the determining unit 220 determines that observation of an object in a direction indicated by an observed direction vector is completed when the degree of coincidence between an observing direction vector and the observed direction vector toward the object is high. For example, when the shape of an object is measured from outside, since it is assumed that an observing direction vector is directed from outside of the object toward the object, that is, toward the inside of the object, the observed direction vector also needs to be directed toward the inside of the object in order to make correct determination. When the shape of an object is measured from inside, on the other hand, since it is assumed that an observing direction vector is directed from inside of the object toward the object, that is, toward the outside of the object, the observed direction vector also needs to be directed toward the outside of the object in order to make correct determination.

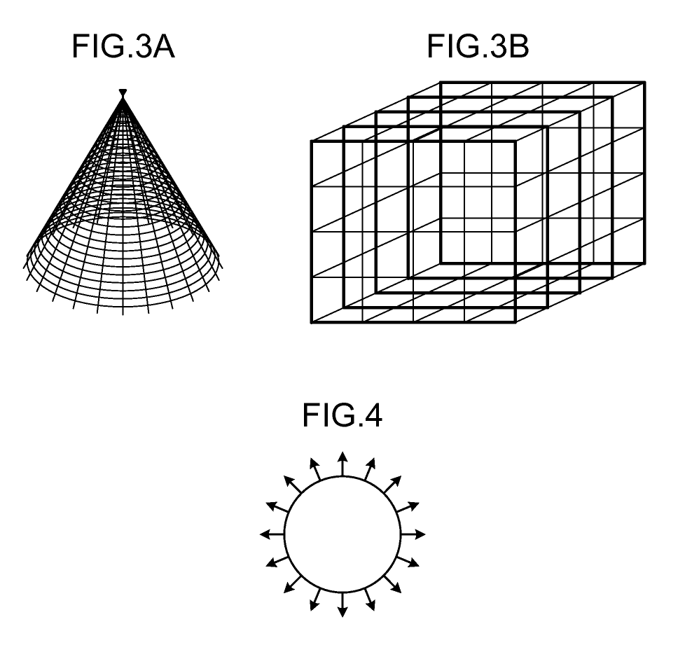

In the example of FIG. 2, since a case in which the shape of an object is measured from outside of the object is assumed, the observed direction vectors are arranged to be directed from around (outside of) the object toward the object (toward the inside). Furthermore, while the shape of the three-dimensional object data is an ellipsoid in the example of FIG. 2, the shape of the three-dimensional object data is not limited thereto and may be a triangular pyramid as illustrated in FIG. 3A or a rectangular parallelepiped (a cube) as illustrated in FIG. 3B. Furthermore, the three-dimensional object data may be first defined and the observed direction vectors may then be identified. For example, if the three-dimensional object data is defined as an ellipsoid and the surface thereof is divided as appropriate to determine the arrangement of the object, the observed direction vectors can be arranged at respective surfaces into which the surface is divided. Furthermore, the length of the observed direction vectors can be set arbitrarily. For example, when the observed direction vectors are regarded as unit vectors, the length of the observed direction vectors may be set to 1.

While the starting points of the observed direction vectors are arranged on the corresponding surfaces (surfaces with which the observed direction vectors intersect at right angles) in the example of FIG. 2, the observed direction vectors are not limited thereto and end points of the observed direction vectors may be arranged on the corresponding surfaces or points in the middle of the observed direction vectors may be arranged on the corresponding surfaces, for example.

While the object is arranged inside of the three-dimensional object data in the example of FIG. 2, such an arrangement of the observed direction vectors cannot be applied to cases in which the shape of an object is measured from inside of the object such as a case in which the shape of a wall surface (object) is measured from inside a room. Accordingly, in cases in which the shape of an object is measured from inside of the object, the observed direction vectors are arranged to be directed from inside of the object toward the object as illustrated in FIG. 4. Since the observed direction vectors in FIG. 4 are directed outward unlike the example of FIG. 2, the observed direction vectors can be applied to cases in which the shape of an object is measured from inside the object. While the shape of the three-dimensional object data is a sphere in the example of FIG. 4, the shape is not limited thereto.

In the embodiment, the observation supporting unit 200 receives input of measurement information indicating whether the shape of an object is to be measured from outside of the object or from inside of the object, and the determining unit 220 obtains (reads out) corresponding three-dimensional object data from the memory that is not illustrated according to the received measurement information. For example, if the obtained measurement information indicates that the shape of the object is to be measured from the outside, the determining unit 220 obtains three-dimensional object data as illustrated in FIG. 2 (three-dimensional object data formed of surfaces that intersect with observed direction vectors arranged to be directed inward). If, on the other hand, the obtained measurement information indicates that the shape of the object is to be measured from the inside, the determining unit 220 obtains three-dimensional object data as illustrated in FIG. 4 (three-dimensional object data formed of surfaces that intersect with observed direction vectors arranged to be directed outward). Alternatively, the configuration may be such that the determining unit 220 receives the input of the measurement information or such that the acquiring unit 210 receives the input of the measurement information and sends the received measurement information to the determining unit 220. Still alternatively, the configuration may be such that the observation supporting unit 200 includes a receiving unit that receives the input of the measurement information separately from the acquiring unit 210 and the determining unit 220 and the measurement information received by the receiving unit is sent to the determining unit 220.

In the embodiment, coordinates where the three-dimensional object data is arranged are represented by (x, y, z), the origin (0, 0, 0) of the coordinates is referred to as a reference point (reference position) of the three-dimensional object, and unless otherwise specified, the origin and scale of the coordinates in real space agree with those of the coordinates where the three-dimensional object data is arranged. For example, when the shape of the three-dimensional object data is an ellipsoid as illustrated in FIG. 2(d), the shape can be expressed by the following equation 1 where the reference point is the center of the ellipsoid.

$$\frac{{x}^{2}}{{a}^{2}} + \frac{{y}^{2}}{{b}^{2}} + \frac{{z}^{2}}{{c}^{2}} = 1 \qquad ( Equation 1 )$$

In the equation 1, a, b and c represent half the lengths of the diameters in the x-axis, y-axis and z-axis directions, respectively.

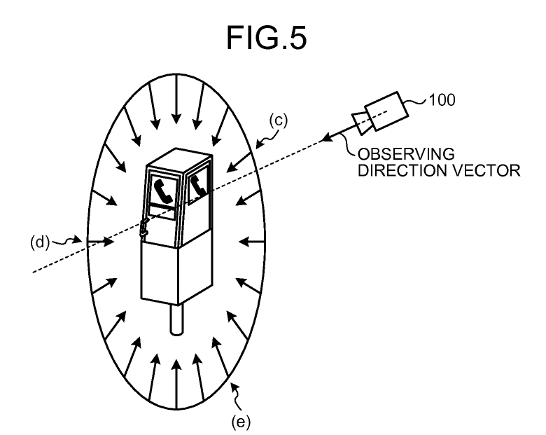

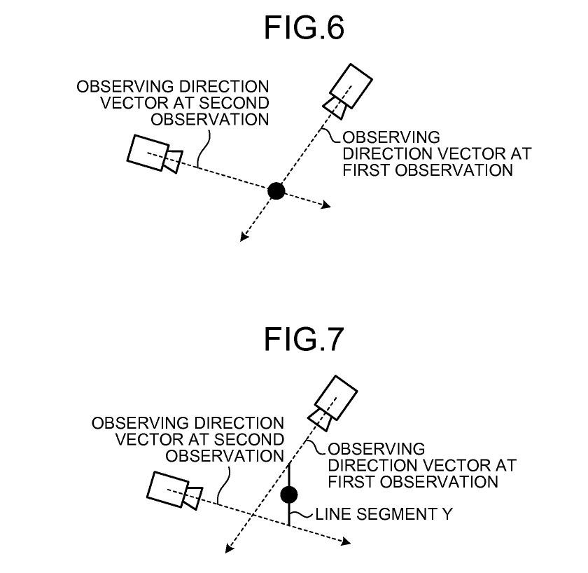

Next, a method for determination performed by the determining unit 220 will be described. In the example of FIG. 5, since an observing direction vector is close to (of a high degree of coincidence with) an observed direction vector (c), observation in the direction indicated by the observed direction vector (c) can be conducted. Since, on the other hand, the observing direction vector is of a low degree of coincidence with each of directions indicated by observed direction vectors (d) and (e), observation in the directions indicated by the observed direction vectors (d) and (e) cannot be conducted. That is, it is possible to determine whether or not observation of object in the direction indicated by an observed direction vector is completed on the basis of the degree of coincidence between the observing direction vector and the observed direction vector.

In the embodiment, the determining unit 220 calculates a scalar product of an observed direction vector and an observing direction vector for each of a plurality of observed direction vectors corresponding one-to-one to a plurality of surfaces forming three-dimensional object data, and if the value of the scalar product is equal to or larger than a threshold, determines that observation of the object in the direction indicated by the observed direction vector is completed. When the determination process is terminated, the determining unit 220 sends determination result information representing the result of the determination process to the generating unit 230. The determination result information may be in any form as long as the determination result information indicates whether or not observation of an object in a direction indicated by an observed direction vector intersecting with each of surfaces forming three-dimensional object data is completed. Note that the threshold can be set arbitrarily according to the range of possible values of the scalar product. For example, when the length of each of the observed direction vectors and the observing direction vectors is 1, the maximum value of the scalar product will be 1 and the threshold may therefore be set to such a value as “0.5” or “0.8”. More accurate observation (measurement of a three-dimensional shape) will be required as the threshold is larger while rougher and simpler observation will be required as the threshold is smaller.

In addition, the determining unit 220 can also adjust the accuracy of observation (in other words, the accuracy of shape measurement) by adjusting the lengths of the observing direction vectors and the observed direction vectors. For example, if the length of the observed direction vectors is larger, the scalar product is likely to be a large value even when the observing direction of the observing unit 100 is shifted from the direction indicated by the observed direction vector. That is, since the scalar product is likely to be larger than the threshold, rough shape measurement can be conducted. Conversely, if the length of the observed direction vectors is smaller, the scalar product will not be large unless the direction indicated by the observing direction vector and the direction indicated by the observed direction vector are approximately coincident. That is, since the scalar product is less likely to be larger than the threshold, highly accurate shape measurement can be conducted as a result.

Furthermore, the determining unit 220 can also variably set the length of the observing direction vectors according to the accuracy of observation by the observing unit 100 (for example, the performance of an observation device or the accuracy of an observation method). For example, the length of the observing direction vectors is set to a large value when observation is conducted by using a highly accurate observation device while the length of the observing direction sectors is set to a small value when observation is conducted by using a less accurate observation device. In this manner, it is possible to reflect the accuracy of observation by the observing unit 100 in the value of the scalar product.

For example, three-dimensional measurement using laser is generally higher in accuracy than measurement using sound waves. Accordingly, it is preferable to set the observing direction vectors to be longer when measurement using laser is to be conducted while it is preferable to set the observing direction vectors to be shorter when measurement using sound waves is to be conducted. When measurement using a camera is conducted, the accuracy of measurement also varies according to the resolution of the camera and the performance of a lens. If the resolution of the camera is high and the performance of the lens is good, highly accurate measurement is possible. In such a case, it is thus preferable to set the observing direction vectors to be longer. Furthermore, the observation accuracy also varies depending on the external environmental conditions at observation. For example, when measurement using a camera is to be conducted, the observation accuracy will be lower in cases where the distance to the object is too far, the environment is dark, or imaging must be conducted in backlit conditions. In such a case, it is preferable to set the observing direction vectors to be shorter.

Furthermore, in measurement using stereo cameras as the observing unit 100, for example, the measurement accuracy will be generally lower as the distance from the object is longer. Thus, the length of the observing direction vectors may be multiplied by a weighting factor w(L) according to the distance L between the observing unit 100 and the object. The weighting factor w(L) can also be expressed by the following equation 2, for example. In the example of the equation 2, the value of the weighting factor w(L) is according to a normal distribution whose argument is the distance L.

$$W ( L ) = 1 - exp ( \frac{{L}^{2}}{{σ}^{2}} ) \qquad ( Equation 2 )$$

In the embodiment, the observation supporting unit 200 receives input of first accuracy information capable of determining the accuracy of observation by the observing unit 100, and the determining unit 220 sets the length of the observing direction vectors according to the received first accuracy information. As described above, examples of the first accuracy information can include information indicating the performance of an observation device, information indicating the observation method, and information indicating current external environmental conditions. The determining unit 220 sets the length of the observing direction vectors to be larger as the accuracy determined by the received first accuracy information is higher. Note that the configuration may be such that the determining unit 220 receives the input of the first accuracy information or such that the acquiring unit 210 receives the input of the first accuracy information and sends the received first accuracy information to the determining unit 220. Alternatively, the configuration may be such that the observation supporting unit 200 includes a receiving unit that receives the input of the first accuracy information separately from the acquiring unit 210 and the determining unit 220 and the first accuracy information received by the receiving unit is sent to the determining unit 220.

Furthermore, the determining unit 220 can also set the length of the observing direction vectors according to the observation accuracy required by the user (the accuracy required for determining whether or not observation in the direction indicated by an observed direction vector is completed). For example, if the user requires that observation be completed quickly (requires less accurate observation), it is considered that the observing direction vectors are set to be longer to conduct observation with lower accuracy. Conversely, if the user requires highly accurate observation, it is considered that the observing direction vectors are set to be shorter to conduct more accurate observation. For adjusting the observation accuracy required by the user as described above, the observed direction vectors may be adjusted instead of adjusting the observing direction vectors. It is preferable to set the observed direction vectors to be shorter if highly accurate measurement is required while it is preferable to set the observed direction vectors to be longer if less accurate measurement is required. This means that the observing direction vectors are adjusted relatively as a result of adjusting the observed direction vectors.

In the embodiment, the observation supporting unit 200 can receive input of second accuracy information capable of determining the accuracy required by the user (the accuracy required for determining whether or not observation in the direction indicated by an observed direction vector is completed), and the determining unit 220 can set the length of the observing direction vector or the observed direction vector according to the received second accuracy information. The determining unit 220 sets the length of the observing direction vectors or the observed direction vectors to be smaller as the accuracy determined by the second accuracy information is higher. Note that the configuration may be such that the determining unit 220 receives the input of the second accuracy information or such that the acquiring unit 210 receives the input of the second accuracy information and sends the received second accuracy information to the determining unit 220. Alternatively, the configuration may be such that the observation supporting unit 200 includes a receiving unit that receives the input of the second accuracy information separately from the acquiring unit 210 and the determining unit 220 and the second accuracy information received by the receiving unit is sent to the determining unit 220.

While it is assumed that the origin and scale of the coordinates in real space agree with those of the coordinates where the three-dimensional object data are arranged in the description above, there may be cases in which the origin and the scale of the coordinates in real space do not agree with those of the coordinates where the three-dimensional object data is arranged. Since the three-dimensional object data exists on another coordinate system while the object and the observing direction vectors exist on the coordinate system in real space, the relation between the two coordinate systems needs to be determined in order to calculate the scalar product with high accuracy. In the following, a method for adjusting the relation between the respective origins and the scale, that is, a method for determining the relation between the two coordinate systems will be described.

First, a method for adjusting the scale will be described. Herein, a method of adjusting the scale on the basis of the size of the object obtained by one or more times of observation is preferable. Since the accuracy of data relating to the size of the object becomes higher as the number of times of observation increases, it is preferable to sequentially perform adjustment of the scale and the determination whether observation is completed. Alternatively, there is also a method of specifying the scale in advance by the user. For example, when the shape of an object is to be measured from outside of the object as illustrated in FIG. 2, it is desirable to arrange three-dimensional object data to enclose the object so as to accurately calculate a scalar product of an observing direction vector and an observed direction vector. Accordingly, in this case, the user can specify the scale of the coordinate system in which the three-dimensional object data is arranged to be a sufficient size for the three-dimensional object data to enclose the object.

Next, the relation between the respective origins will be described. Although there may be cases in which the origin of the coordinates in real space and the origin of the coordinates in which three-dimensional object data is arranged are not coincident unlike the description above, the relation between the two origins can be expressed by simple parallel translation or affine transformation and transformation between the two coordinate systems is easy. It is therefore possible to calculate the scalar product with high accuracy.

The determining unit 220 can also determine the origin (the reference position) of three-dimensional object data on the basis of the observing direction vectors. For example, if the origin of three-dimensional object data is to be set by conducting observation once, a method of setting the origin of the three-dimensional object data on an extension of the observing direction vector can be considered. The position of the origin on the extension may be arbitrarily set or may be determined on the basis of the scale. If the origin of the three-dimensional object data is to be set by performing observation two or more times, the following method can be considered.

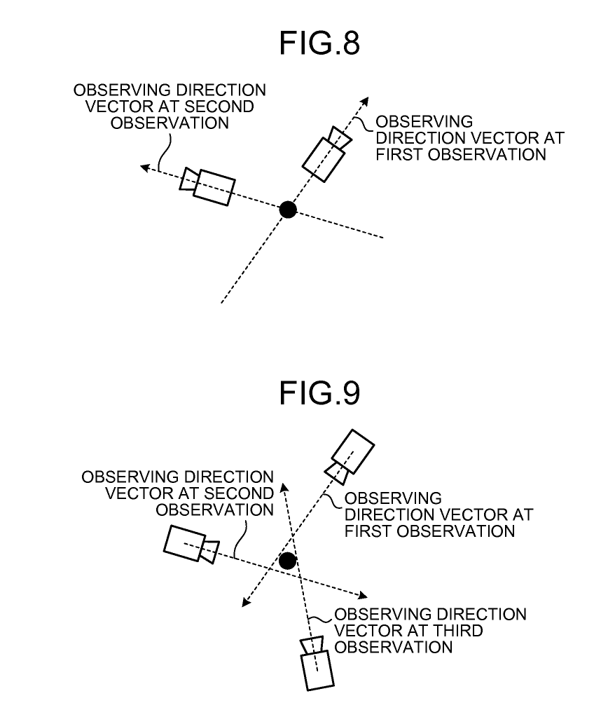

For example, if the number of times of observation is two, an intersection of an extension of the observing direction vector at the first observation with an extension of the observing direction vector at the second observation may be set as the origin of the three-dimensional object data. If the extension of the observing direction vector at the first observation and the extension of the observing direction vector at the second observation do not intersect with each other, the midpoint of a line segment Y intersecting at right angles with the extension of the observing direction vector at the first observation and the extension of the observing direction vector at the second observation may be set as the origin of the three-dimensional object data as illustrated in FIG. 7. If the observing direction vector is directed outward (when the shape of the object is to be measured from inside of the object), for example, an intersection of an extension extending in a direction opposite to the direction in which the observing direction vector is directed at the first observation (extending inward in this example) with an extension extending in a direction opposite to the direction in which the observing direction vector is directed in the second observation may be set as the origin of the three-dimensional object data as illustrated in FIG. 8.

Alternatively, if the number of times of observation is three or more as illustrated in FIG. 9, for example, a point where a sum of distances from an extension of the observing direction vector at the first observation, an extension of the observing direction vector at the second observation and an extension of the observing direction vector at the third observation is the minimum may be set as the origin of the three-dimensional object data. Still alternatively, the position of a median point of a three-dimensional model generated so far may be set as the origin of the three-dimensional object data, for example.

The description will be continued referring back to FIG. 1. The generating unit 230 generates completion information indicating whether or not observation of an object in a direction indicated by an observed direction vector is completed on the basis of the determination result information (information indicating the result of the determination process) received from the determining unit 220. Any type of completion information may be used, such as an image or sound. In the embodiment, the generating unit 230 generates image data capable of identifying whether or not observation of the object in the direction indicated by an observed direction vector intersecting with each of surfaces forming three-dimensional object data is completed as completion information. More specifically, the generating unit 230 generates image data in which a specific color (such as red) is given to a surface for which it is determined that observation in a direction indicated by an observed direction vector intersecting with the surface is completed (for which it is determined that the scalar product of the observing direction vector and the observed direction vector intersecting with the surface is equal to or larger than the threshold) among the surfaces forming the three-dimensional object data as the completion information.

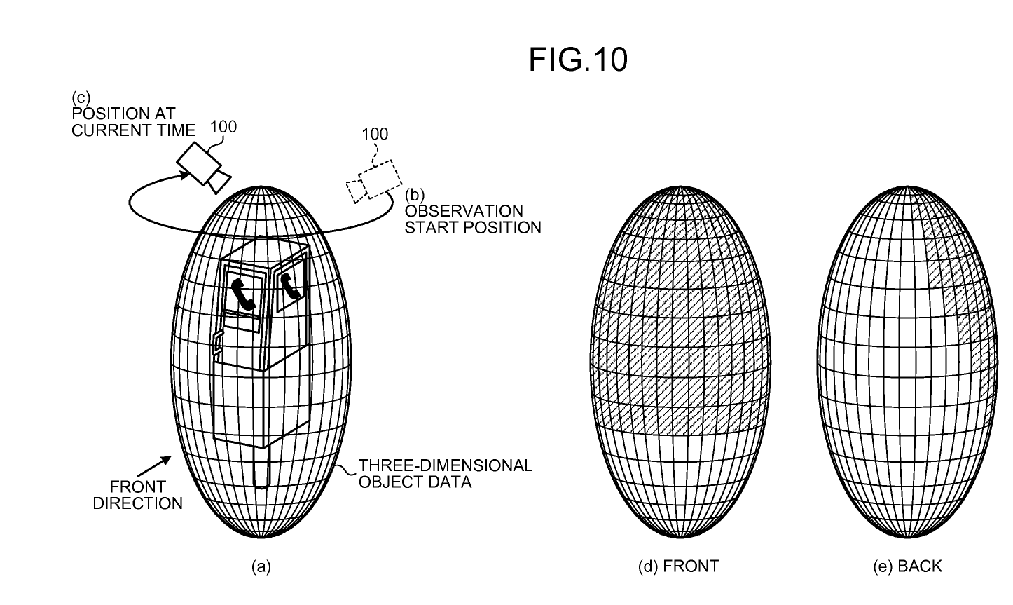

FIG. 10 is a diagram illustrating an example of the completion information generated by the generating unit 230. FIG. 10 illustrates a case in which the shape of an object is to be measured from outside of the object, and three-dimensional object data is arranged to enclose the object as illustrated in (a) of FIG. 10. When observation of the object is continuously conducted from the position (the position of the observing unit 100 at the start of observation) illustrated in (b) of FIG. 10 to the position (the position of the observing unit 100 at the current time) illustrated in (c) of FIG. 10, observation of the upper part of the front and part of the back of the three-dimensional object data will be completed as illustrated in (d) and (e) of FIG. 10. In the example of FIG. 10, a surface for which it is determined that observation is completed (a surface for which it is determined that the scalar product of the observing direction vector and an observed direction vector intersecting with the surface is equal to or larger than the threshold) is displayed in read (hatched in FIG. 10). That is, to a surface for which it is determined that observation is completed, color information of red is given as identification information indicating that observation in the direction indicated by the observed direction vector intersecting with the surface is completed. On the other hand, color information is not given to a surface for which it is determined that observation has not been completed (a surface for which it is determined that the scalar product of the observing direction vector and an observed direction vector intersecting with the surface is smaller than the threshold).

As described above, in the embodiment, the generating unit 230 generates an image data in which color information is given to surfaces for which it is determined that observation is completed among the surfaces forming the three-dimensional object data as the completion information. Herein, the generating unit 230 generates image data of (d) and image data of (e) as the completion information.

While completion of observation is indicated by displaying a surface for which it is determined that observation is completed in red among the surfaces forming the three-dimensional object data, completion of observation may be displayed in other manners. For example, completion of observation may be indicated by superposing or displaying a shaded or hatched pattern, surrounding with a closing line, superposing or displaying a specific color other than red, displaying in black or blinking. Furthermore, while color information is given to a surface for which it is determined that observation is completed in the example of FIG. 10, color information may be given to a surface for which it is determined that observation has not been completed and not given to a surface for which it is determined that observation is completed in the other way around so as to identify the surface for which observation is completed, or the configurations described above may be combined.

While the generating unit 230 generates image data capable of identifying whether or not observation of the object in the direction indicated by an observed direction vector intersecting with each of surfaces forming three-dimensional object data is completed as the completion information as described above in the embodiment, the completion information is not limited thereto. For example, the generating unit 230 may generate image data that is subjected to processing such as giving a color to observed direction vectors as the completion information. Basically, the completion information may be any information indicating whether or not observation of an object in a direction indicated by an observed direction vector is completed.

Furthermore, while surfaces of three-dimensional object data to which color information is given is plain in the example of FIG. 10, the surfaces are not limited thereto and data such as an image obtained during observation may be superposed on the surfaces, for example. Furthermore, while image data in which the three-dimensional object data to which color information is given is divided as if observation is conducted from two points of view, which are the front and the back, are generated in the embodiment, image data in which the three-dimensional object data is further divided (image data divided as if the three-dimensional object data to which color information is given is observed from three or more points of view) may alternatively be generated or image data in which the three-dimensional object data to which color information is given is automatically rotated so that all the surfaces can be observed may be alternatively generated. Still further, the configuration may be such that part that is displayed of the three-dimensional object data to which color information is given is changed according to the instruction of the user.

Furthermore, the generating unit 230 can generate current position information indicating the current position of the observing unit 100 and generate path information indicating the path of the observing unit 100. The generating unit 230 can also generate information indicating a next observing position for more efficiently observing unobserved parts. Still further, the generating unit 230 can also generate information indicating whether or not the entire observation is completed. That is, the generating unit 230 can generate status information indicating whether or not the entire observation of the object in all directions indicated by a plurality of predetermined observed direction vectors is completed. The generating unit 230 send the information (completion information and the like) generated as described above to the informing unit 300.

The description will be provided referring back to FIG. 1. The informing unit 300 informs the user of the observation system 1 of the completion information generated by the generating unit 230. For example, when the completion information is image data as in the embodiment, the informing unit 300 is a display device capable of displaying images and displays the completion information generated by the generating unit 230. As a result, the user is informed of the completion information generated by the generating unit 230. Any type of display device may be used, such as a typical display device for two-dimensional display, a stereoscopic video display device, a display device having a special display that is not flat, or a projection display such as a projector. Note that the informing unit 300 may be in a form like a typical TV, in a form like a display panel attached to the observation device, or in a form like a display panel attached to a portable terminal that the user have. Furthermore, the informing unit 300 can help informing of the completion information by displaying a text and outputting audio.

When the completion information is audio data, for example, the informing unit 300 is a speaker or the like and outputs the completion information generated by the generating unit 230 in audio. As a result, the user is informed of the completion information generated by the generating unit 230. That is, the information may be in any form such as display of an image or output of audio. The informing unit 300 can also inform information other than the completion information generated by the generating unit 230, such as the current position information and the status information as described above. Regarding such information, the informing unit 300 may be configured to inform the user by displaying an image, a text and the like or to inform the user by outputting audio.

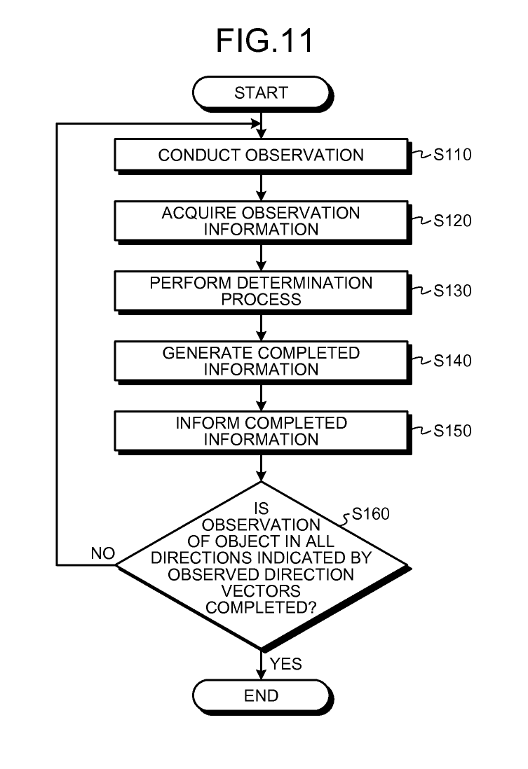

FIG. 11 is a flowchart illustrating an example of processing performed by the observation system 1. As illustrated in FIG. 11, the observing unit 100 first conducts observation of an object (step S110). The acquiring unit 210 acquires observation data representing a result of observation by the observing unit 100 and observation information (such as information indicating the position and the posture of the observing unit 100) that can identify an observing direction vector (step S120). The determining unit 220 performs the determining process described above (step S130). More specifically, the determining unit 220 identifies an observing direction vector from the observation information acquired by the acquiring unit 210. The determining unit 220 then determines whether or not observation of the object in the direction indicated by an observed direction information is completed on the basis of the degree of coincidence (the scalar product in this example) of the identified observing direction vector and an observed direction vector intersecting with each of the surfaces of the three-dimensional object data. When the determination process is terminated, the determining unit 220 sends determination result information representing the result of the determination process to the generating unit 230.

The generating unit 230 generates the completion information on the basis of the determination result information from the determining unit 220 (step S140). The generating unit 230 then sends the generated completion information to the informing unit 300, and the informing unit 300 performs information of the completion information received from the generating unit 230 (step S150). The generating unit 230 determines whether or not observation of the object is completed in the directions indicated by all the observed direction vectors (step S160), and if it is determined that there is a direction in which observation is not conducted among the directions indicated by all the observed direction vectors (if the result of step S160 is NO), the processing is returned to step S110 described above. If, on the other hand, it is determined that observation of the object in the directions indicated by all the observed direction vectors is completed (if the result of step S160 is YES), the processing is terminated.

As described above, in the embodiment, since it is determined whether or not observation of the object is completed in the direction indicated by an observed direction vector on the basis of the degree of coincidence of the observing direction vector and the observed direction vector toward the object, it is possible to correctly determine whether or not observation of the object in the direction indicated by an observed direction vector in both of cases where the object is observed from the outside and cases where the object is observed from the inside. In addition, as a result of generating the completion information indicating whether or not observation of the object is completed in the direction indicated by an observed direction vector, it is possible to correctly indicate whether or not there is any direction in which observation has not been conducted. With the embodiment, therefore, omission in measurement of a three-dimensional shape of an object for which a three-dimensional model is to be formed can be prevented.

For example, while the scalar product is employed as the degree of coincidence of the observing direction vector and an observed direction vector in the embodiment described above, the type of the degree of coincidence is not limited thereto by any type of the degree of coincidence may be used. For example, a difference between or an outer product of the observing direction vector and an observed direction vector may be employed as the degree of coincidence. When the difference between or the outer product of the observing direction vector and an observed direction vector is employed as the degree of coincidence, if the value of the calculated difference of outer product is smaller than a predetermined value, the determining unit 220 can determine that the observing direction vector is close to the observed direction vector, that is, the degree of coincidence is high and that observation of the object in the direction indicated by the observed direction vector is completed.

The observation supporting unit 200 described above has a hardware configuration including a central processing unit (CPU), a ROM, a RAM, a communication interface unit and other components. The functions of the respective units (the acquiring unit 210, the determining unit 220 and the generating unit 230) of the observation supporting unit 200 described above are realized by expanding programs stored in the ROM on the RAM and executing the programs by the CPU. Alternatively, at least some of the functions of the respective units (the acquiring unit 210, the determining unit 220 and the generating unit 230) may be implemented by separate dedicated circuits (hardware). Note that the observation supporting unit 200 described above corresponds to an “observation support device” in the claims.

In addition, the programs to be executed by the observation supporting unit 200 in the embodiment described above may be stored on a computer system connected to a network such as the Internet, and provided by being downloaded via the network. Alternatively, the programs to be executed by the observation supporting unit 200 in the embodiment described above may be provided or distributed through a network such as the Internet. Still alternatively, the programs to be executed by the observation supporting unit 200 in the embodiment described above may be embedded on a ROM or the like in advance and provided therefrom.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An observation support device, comprising:
an acquiring unit configured to acquire observation information capable of identifying an observing direction vector indicating an observing direction of an observing unit that observes an object for which a three-dimensional model is to be generated;
a determining unit configured to determine whether or not observation of the object in a direction indicated by an observed direction vector in which at least part of the object can be observed is completed based on a degree of coincidence of the observing direction vector and the observed direction vector; and
a generating unit configured to generate completion information indicating whether or not observation of the object in the direction indicated by the observed direction vector is completed.

2. The device according to claim 1, wherein
the determining unit
uses three-dimensional object data representing a three-dimensional object formed of a plurality of surfaces corresponding one-to-one to a plurality of predetermined observed direction vectors, each of the surfaces intersecting with the corresponding observed direction vector, and
determines, for each of the surface of the three-dimensional object, whether or not observation of the object is completed in a direction indicated by the corresponding observed direction vector, based on a degree of coincidence of the observing direction vector and the corresponding observed direction vector intersecting with the surface.

3. The device according to claim 2, wherein the generating unit generates image data capable of identifying whether or not observation of the object is completed in a direction indicated by the observed direction vector intersecting with each of the surfaces as the completion information.

4. The device according to claim 1, wherein the degree of coincidence is a scalar product of the observing direction vector and the observed direction vector.

5. The device according to claim 4, wherein if a value of the scalar product of the observing direction vector and the observed direction vector is equal to or larger than a threshold, the determining unit determines that observation of the object in the direction indicated by the observed direction vector is completed.

6. The device according to claim 2, wherein the determining unit determines a reference position of the three-dimensional object data based on the observing direction vector.

7. The device according to claim 1, wherein the determining unit sets a length of the observing direction vector according to first accuracy information capable of determining accuracy of observation by the observing unit.

8. The device according to claim 1, wherein the determining unit sets a length of the observing direction vector or the observed direction vector according to second accuracy information capable of determining accuracy required for determining whether or not observation of the object in a direction indicated by the observed direction vector is completed.

9. An observation support method, comprising:
acquiring observation information capable of identifying an observing direction vector indicating an observing direction of an observing unit that observes an object for which a three-dimensional model is to be generated;
determining whether or not observation of the object in a direction indicated by an observed direction vector in which at least part of the object can be observed is completed based on a degree of coincidence of the observing direction vector and the observed direction vector; and
generating completion information indicating whether or not observation of the object in the direction indicated by the observed direction vector is completed.

10. A computer program product comprising a computer-readable medium including an observation support program, wherein the program, when executed by a computer, causes the computer to function as:
an acquiring unit configured to acquire observation information capable of identifying an observing direction vector indicating an observing direction of an observing unit that observes an object for which a three-dimensional model is to be generated;
a determining unit configured to determine whether or not observation of the object in a direction indicated by an observed direction vector in which at least part of the object can be observed is completed based on a degree of coincidence of the observing direction vector and the observed direction vector; and
a generating unit configured to generate completion information indicating whether or not observation of the object in the direction indicated by the observed direction vector is completed.
